(19) United States
(12) Patent Application Publication
(10) Pub. No.: US 2022/0127012 A1
(43) Pub. Date: Apr. 28, 2022

(54) GEAR SHROUDING WITH INTEGRAL LUBRICATING FEATURES

(71) Applicant: Bell Textron Inc., Fort Worth, TX (US)

(72) Inventors: Gregory Alan Spruce, Grand Prairie, TX (US); Alan Wayne Falls, Arlington, TX (US); Douglas Robert Mueller, Coppell, TX (US)

(21) Appl. No.: 17/079,978

(22) Filed: Oct. 26, 2020

(51) Int. Cl. B64D 35/00; B64C 27/12; F16H 57/04

(52) U.S. Cl. CPC B64D 35/00; F16H 57/0457; B64C 27/12

(57) ABSTRACT

In one embodiment of the present disclosure, there is provided an aircraft gearbox including a gear and a gear shrouding for providing lubrication to the gear. The gear shrouding is disposed around the gear, has an inner surface facing the gear and an opposing outer surface facing away from the gear, and includes a channel formed along at least a portion of the gear shrouding between the inner surface and the outer surface of the gear shrouding, an input orifice extending to the channel, wherein the input orifice is at a first position on the channel, and an output orifice extending to the channel, wherein the output orifice is at a second position on the channel different from the first position. In another embodiment, the gear shrouding further includes a second output orifice at a third position on the channel different from the first and second positions.

### TECHNICAL FIELD

This disclosure relates generally to aircraft gearboxes, and more particularly, though not exclusively, to systems, and methods for lubricating aircraft gearbox components.

### BACKGROUND

An aircraft generally includes one or more gearboxes housing a plurality of gears. A gearbox transmits power from a power source to an object to be moved, such as from an engine to a propeller. Gears, bearings, and other mechanical components of a gearbox are subject to wear and heat generation due to contact with other components. A gearbox typically includes lubrication systems that lubricate the mechanical components to reduce friction and transfer heat away from the components. If a lubricant is not supplied to a gearbox component effectively and in sufficient quantity, the gearbox component may degrade or fail. Some contemporary gearbox lubrication systems include mounting lubrication lines and nozzles on the gearbox housing to dispense lubricant on the gears, bearings, and other mechanical components of the gearbox. Other contemporary gearbox lubrication systems include a gear shroud disposed within a gearbox in physical contact with a lubricant such that the lubricant is distributed through the gearbox by operation of the gear turning. These contemporary solutions may fail to supply a lubricant effectively and sufficiently, for example, due to the dispensing mechanism being mounted on the gearbox and positioned too far from the gear or due to the dispensing mechanism relying on indirect distribution of lubricant on the gear. Systems and methods for providing improved lubrication to gearbox components are desired.

### SUMMARY

According to one aspect of the present disclosure, there is provided an aircraft gearbox that includes a gear shrouding with integral features for lubricating a gear. The gear shrouding includes a channel, an input orifice connected to the channel at a first position, and an output orifice connected to the channel at a second position different from the first position. During operation, a lubricant flows through the input orifice, the channel, and the output orifice, and is dispensed on the gear and other gearbox components. The gear shrouding may include a plurality of channels and a plurality of output orifices positioned on the gear shrouding adjacent to gearbox components needing lubrication so that the lubricant may be efficiently, sufficiently, and directly dispensed to those components. An output orifice may be through an inner surface of the gear shrouding facing the gear or through an outer surface of the gear shrouding facing away from the gear depending on where lubricant needs to be dispensed.

### BRIEF DESCRIPTION OF THE DRAWINGS

FIG. 1A is a perspective view of a tiltrotor aircraft in helicopter mode, in accordance with certain embodiments.

FIGS. 1B-1C are perspective views of a tiltrotor aircraft in airplane mode, in accordance with certain embodiments.

FIG. 2A is a side view of a rotorcraft, in accordance with certain embodiments.

FIG. 2B is a perspective view of a rotorcraft, in accordance with certain embodiments.

FIG. 3 is a perspective view of an exemplary gear shrouding with integral lubricating features, in accordance with various embodiments.

FIG. 4 is a simplified diagram of the exemplary gear shrouding of FIG. 3, in accordance with various embodiments.

FIG. 5 is a cross sectional view along the A-A′ line of the exemplary gear shrouding of FIG. 4, in accordance with various embodiments.

FIG. 6 is a simplified diagram of another exemplary gear shrouding with integral lubricating features, in accordance with various embodiments.

FIG. 7 is a cross-sectional, side view of the exemplary gear shrouding of FIG. 6, in accordance with various embodiments.

### DETAILED DESCRIPTION

A gear shrouding having integral features for lubricating a gear in an aircraft gearbox includes a channel, an input orifice extending to and at a first position on the channel, and an output orifice extending to and at a second position on the channel different from the first position. During operation, a lubricant source is connected to the input orifice on the gear shrouding such that lubricant flows through the input orifice, the channel, and the output orifice, and is dispensed on the gear. The gear shrouding may further include a second output orifice extending to and at a third position on the channel different from the first position and the second position. In various embodiments, the first and second output orifices are through an inner surface of the gear shrouding facing the gear. In various embodiments, the first and second output orifices are through an outer surface of the gear shrouding facing away from the gear. The gear shrouding may further include a second channel, where the input orifice extends to the second channel, and a second output orifice extending to and at a third position on the second channel different from the first position.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction.

As used herein, the terms shroud and shrouding may be used interchangeably. As used herein, the terms channel, core, and tunnel may be used interchangeably and refer to a fluid pathway within the gear shrouding. As used herein, the terms orifice, opening, jet, and jet shot may be used interchangeably and refer to an outlet connected to the fluid pathway for dispensing lubricant on a component covered by the gear shrouding. Further, the present disclosure may repeat reference numerals and/or letters in the various examples where like numerals designate like parts throughout, and in which is shown, by way of illustration, embodiments that may be practiced. This repetition is for the purpose of simplicity and clarity and does not in itself dictate a relationship between the various embodiments and/or configurations discussed. It is to be understood that other embodiments may be utilized, and structural or logical changes may be made without departing from the scope of the present disclosure. For convenience, numerals that designate multiples of a same element may be used to refer to the collection of the same element. For example, the phrase “channel 306” may be used to refer to “channels 306A, 306B, 306C, 306D.” When used to describe a range of dimensions, the phrase “between X and Y” represents a range that includes X and Y. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The drawings are not necessarily to scale.

Example embodiments that may be used to implement the features and functionality of this disclosure will now be described with more particular reference to the attached FIGURES.

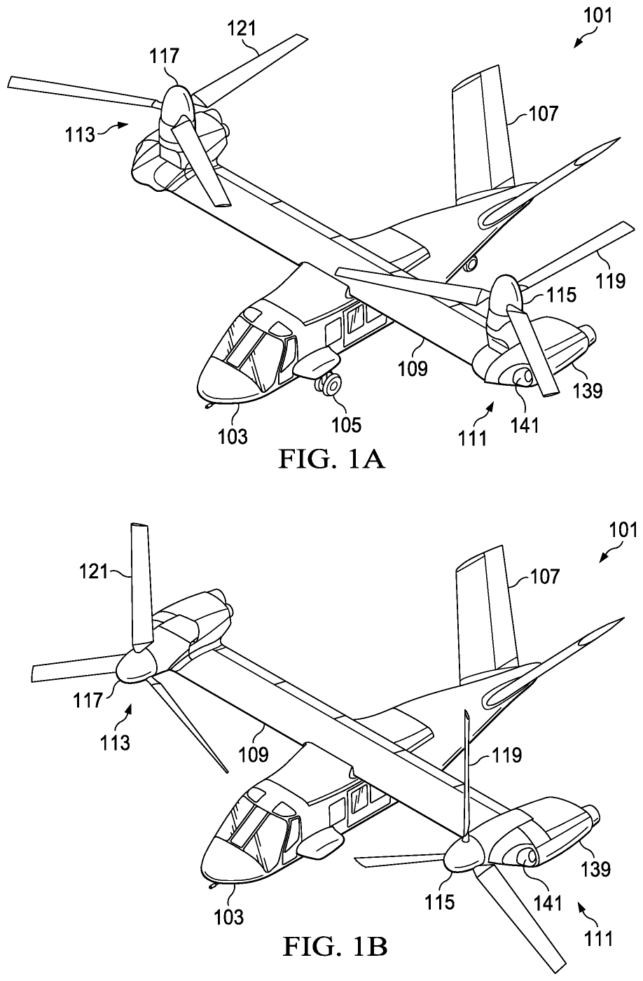

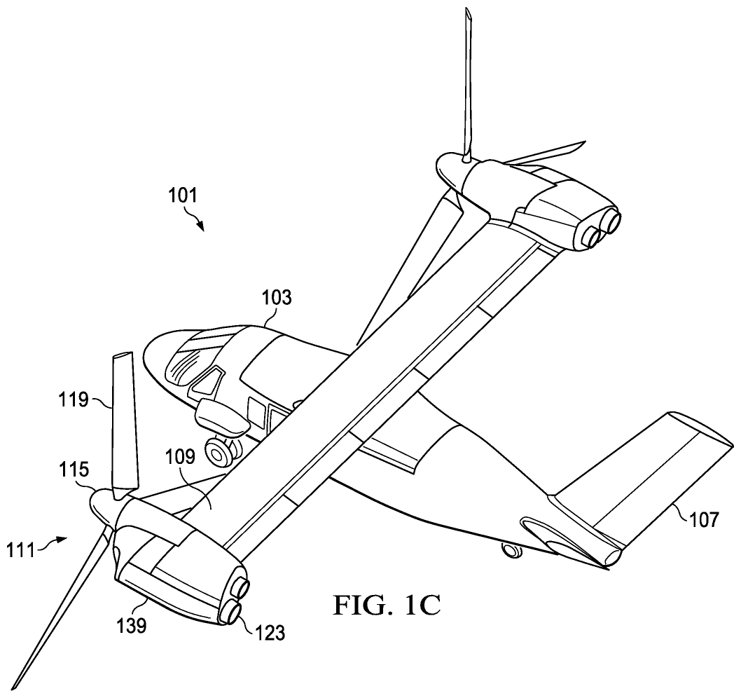

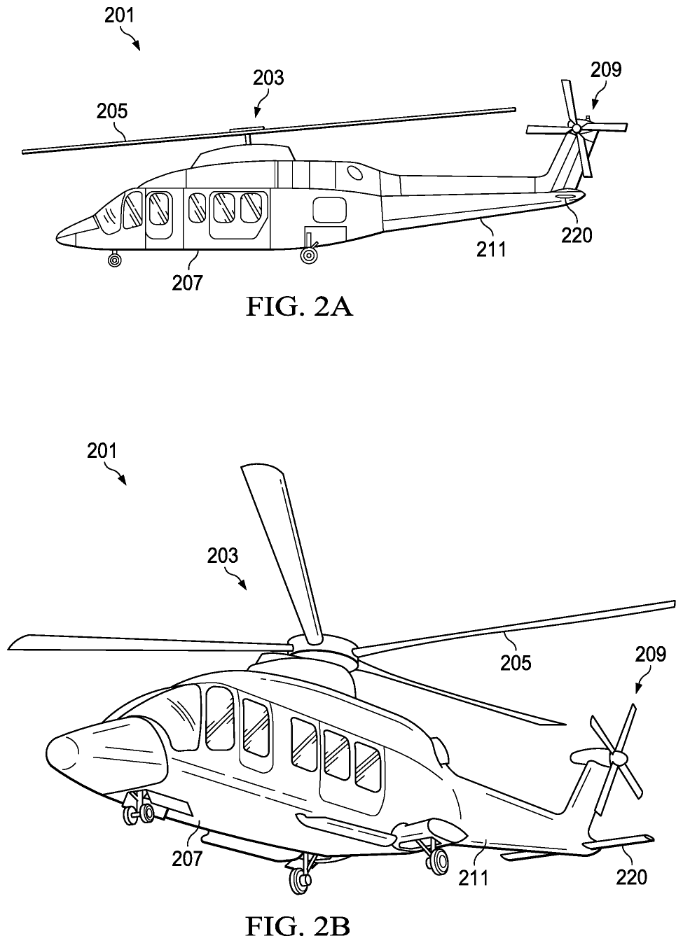

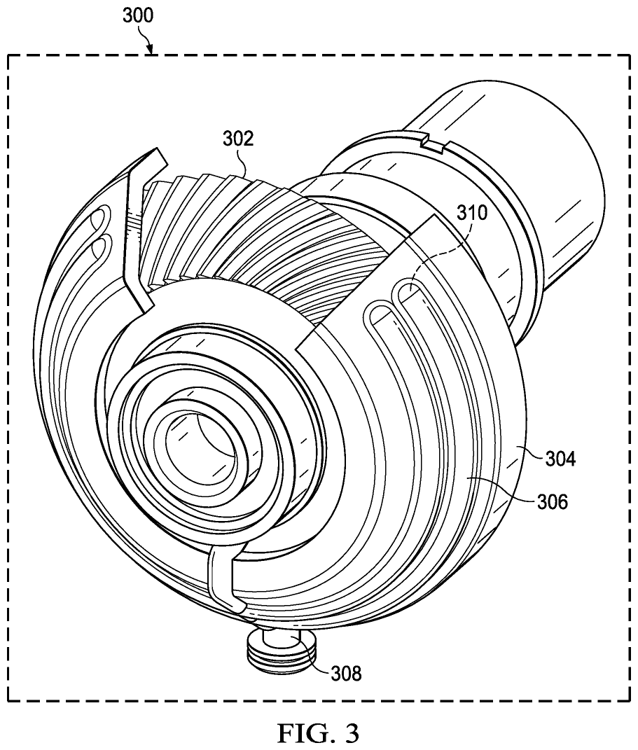

FIGS. 1A-1C and 2A-2B illustrate various example aircraft in accordance with certain embodiments, as discussed further below.

Referring to FIGS. 1A-1C, a tiltrotor aircraft 101 is illustrated. Tiltrotor aircraft 101 may include a fuselage 103, a landing gear 105, a tail member 107, a wing 109, a propulsion system 111, and a propulsion system 113. Each propulsion system 111 and 113 includes a fixed engine and a rotatable proprotor 115 and 117, respectively. Each rotatable proprotor 115 and 117 have a plurality of rotor blades 119 and 121, respectively, associated therewith. The position of proprotors 115 and 117, as well as the pitch of rotor blades 119 and 121, can be selectively controlled in order to selectively control direction, thrust, and lift of tiltrotor aircraft 101.

FIG. 1A illustrates tiltrotor aircraft 101 in helicopter mode, in which proprotors 115 and 117 are positioned substantially vertical to provide a lifting thrust. FIGS. 1B and 1C illustrate tiltrotor aircraft 101 in an airplane mode, in which proprotors 115 and 117 are positioned substantially horizontal to provide a forward thrust in which a lifting force is supplied by wing 109. It should be appreciated that tiltrotor aircraft can be operated such that proprotors 115 and 117 are selectively positioned between airplane mode and helicopter mode, which can be referred to as a conversion mode.

The propulsion system 113 is substantially symmetric to the propulsion system 111; therefore, for sake of efficiency certain features will be disclosed only with regard to propulsion system 111. However, one of ordinary skill in the art would fully appreciate an understanding of propulsion system 113 based upon the disclosure herein of propulsion system 111. Further, propulsion systems 111 and 113 are illustrated in the context of tiltrotor aircraft 101; however, propulsion systems 111 and 113 can be implemented on other tiltrotor aircraft. For example, an alternative embodiment may include a quad tiltrotor that has an additional wing member aft of wing 109, the additional wing member can have additional propulsion systems similar to propulsion systems 111 and 113. In another embodiment, propulsion systems 111 and 113 can be used with an unmanned version of tiltrotor aircraft 101. Further, propulsion systems 111 and 113 can be integrated into a variety of tiltrotor aircraft configurations.

As shown in FIG. 1C, propulsion system 111 includes an engine 123 that is fixed relative to wing 109. Engine 123 can be housed and supported in an engine nacelle 139. Engine nacelle 139 can include an inlet 141, aerodynamic fairings, and exhaust, as well as other structures and systems to support and facilitate the operation of engine 123. An aircraft, such as tiltrotor aircraft 101, may include one or more gearboxes housing a plurality of gears. For example, a gearbox may be part of the propulsion system 111 housed in the engine nacelle 139. A gearbox may transmit power from a power source (e.g., engine 123) to an object to be moved (e.g., proprotor 115). Examples of gearboxes include a spiral bevel gearbox (also commonly referred to as a nose-box), a spindle gearbox, a proprotor gearbox, an accessory gearbox, a reduction gearbox, a combining gearbox, a main rotor gearbox, and a tail rotor gearbox. For example, during flight, an engine output shaft transfers power from an engine (e.g., engine 123 of FIG. 1C) to a spiral bevel gearbox that includes spiral bevel gears to change torque direction by 90 degrees from the engine to a fixed gearbox via a clutch. In another example, a fixed gearbox includes a plurality of gears, such as helical gears, in a gear train that are coupled to an interconnect drive shaft and a quill shaft, which transfer torque to a spindle gearbox. In yet another example, a variable-speed transmission is a gearbox that may be “shifted” to dynamically change the speed-to-torque ratio.

FIGS. 2A-2B illustrate an example embodiment of a rotorcraft 201. FIG. 2A illustrates a side view of rotorcraft 201, while FIG. 2B illustrates a perspective view of rotorcraft 201. Rotorcraft 201 has a rotor system 203 with a plurality of rotor blades 205. The pitch of each rotor blade 205 may be managed or adjusted in order to selectively control direction, thrust, and lift of rotorcraft 201. Rotorcraft 201 further includes a fuselage 207, anti-torque system 209, an empennage 211, and a tail structure 220. In this example, tail structure 220 can represent a horizontal stabilizer. Torque is supplied to rotor system 203 and anti-torque system 209 using at least one engine. An aircraft, such as rotorcraft 201, may include one or more gearboxes housing a plurality of gears.

It should be appreciated that tiltrotor aircraft 101 of FIGS. 1A-1C and rotorcraft 201 of FIGS. 2A-2B, are merely illustrative of a variety of aircraft having gearboxes that can be used to implement embodiments of the present disclosure. Other aircraft implementations can include, for example, fixed wing airplanes, hybrid aircraft, unmanned aircraft, gyrocopters, and a variety of helicopter configurations, among other examples. Moreover, it should be appreciated that even though aircraft are particularly well suited to implement embodiments of the present disclosure, the described embodiments can also be implemented using non-aircraft vehicles and devices.

As described above, a gearbox may transmit power from a power source to an object to be moved. A gearbox may convert speed and torque between the power source and the object to be moved. A gearbox may include various gears, bearings, and other mechanical components of the gearbox. A gearbox may further include a gear shrouding that closely covers a gear to prevent efficiency and power losses. A gear is a rotating machine having teeth that mesh with another toothed part in order to transmit torque. Gears in a gearbox may be used to provide speed and torque conversions. A bearing may include any of various machine elements that constrain the relative motion between two or more parts to only the desired motion. Bearings in a gearbox may perform tasks such as supporting a gear shaft. Gears, bearings, gear meshes, and other mechanical components of a gearbox are subject to wear and heat generation due to contact with other components. A gearbox may further include lubrication systems that lubricate the mechanical components to reduce friction and transfer heat away from the components. Lubrication is the process or technique employed to reduce wear of one or both surfaces in close proximity, and moving relative to each other, by interposing a substance (lubricant) between the surfaces to help carry the load (pressure generated) between the opposing surfaces. A lubricant is a substance introduced to reduce friction between moving surfaces. Examples of lubricants include oil, biolubricants derived from plants and animals, synthetic oils, solid lubricants, and aqueous lubricants.

A gearbox including a gear shrouding with integral lubricating features is disclosed herein. The gear shrouding, having an inner surface and an opposing outer surface, including a channel formed along at least a portion of the gear shrouding between the inner and outer surfaces, an input orifice connected to the channel at a first position, and an output orifice connected to the channel at a second position, where the second position is different from the first position. When the gear shrouding having integral lubricating features is operational, a lubricant enters through the input orifice, flows through the channel, and exits through the output orifice to be dispensed on a gear, a bearing, and/or other gearbox component that is covered by or positioned adjacent to the gear shrouding. The gear shrouding may have any suitable number and arrangement of input orifices, channels, and output orifices. For example, the gear shrouding may include one or more channels, one or more input orifices, and one or more output orifices. In some embodiments, a gear shrouding having a plurality of channels may include a single input orifice connected to the plurality of channels. In some embodiments, a gear shrouding having a plurality of channels may include an individual input orifice connected to an individual channel for each of the plurality of channels. In some embodiments, a gear shrouding one or more input orifices connected to one or more channels of the plurality of channels. In some embodiments, the input orifice is positioned below or lower than the output orifice within the gear shrouding. For example, when operational, the input orifice of the gear shrouding positioned below the output orifice may be connected to a pump such that the lubricant is pressurized and pumped into the input orifice, thorough the channel, and dispensed out the output orifice. In some embodiments, the input orifice may be positioned above or higher than the output orifice within the gear shrouding (e.g., as depicted in FIG. 6). For example, when operational, the input orifice positioned above the output orifice may be connected to a lubricant source such that the lubricant flows from the input orifice, through the channel, and through the output orifice by gravity-driven fluid flow. An input orifice, a channel, and an output orifice may have any suitable dimensions. The dimensions of the input orifice, the channel, and the output orifice may be based on a size of the gear shrouding, a number of input orifices, a number of channels, a length of a channel, a number of output orifices, a flow rate and/or pressure of the lubricant, and a material of the gear shroud. For example, a gear shrouding may include an input orifice diameter between 0.1 and 1.0 inches, a channel diameter between 0.1 and 1.0 inches, and an output orifice diameter between 0.01 and 0.10 inches. In another example, in some embodiments, a gear shrouding may include an input orifice diameter between 0.12 and 0.75 inches, a channel diameter between 0.12 and 0.75 inches, and an output orifice diameter between 0.01 and 0.06 inches.

The embodiments described throughout this disclosure provide numerous technical advantages, including reducing part count, assembly complexity, and cost associated with lubricating gearbox components within or adjacent to a gear shrouding. Further, the gear shrouding with integral lubricating features enables for directly, and at close proximity, dispensing lubricant on multiple gearbox components.

Example embodiments that may be used to implement the gear shrouding with integral lubricating features for lubricating gearbox components, are described below with more particular reference to the remaining FIGURES.

FIG. 3 is a perspective view of an exemplary gear shrouding with integral lubricating features, in accordance with various embodiments. As shown in FIG. 3, an aircraft gearbox 300 includes a gear 302 and a gear shrouding 304 having integral lubricating features covering the gear 302. The gear shrouding 304 has an outer surface facing away from the gear 302 and an inner surface facing towards the gear 302. As shown in FIG. 3, the gear shrouding 304 has a circular portion that partly surrounds the gear 302. The gear shrouding 304 includes an input orifice 308, a channel 306, and an output orifice 310 on an inner surface of the gear shrouding 304. The input orifice 308 is at a first position on the channel (e.g., at a first location along a dimension, or length, of the channel) and the output orifice 310 is at a second position on the channel (e.g., at a second location along a dimension, or length, of the channel), where the second position is different from the first position. For example, as depicted in FIG. 3, the gear shrouding 304 further may include a channel formed along at least a portion of a circumference of the gear shrouding between the inner surface and the outer surface of the gear shrouding, an input orifice formed through the outer surface of the gear shrouding extending to the channel, wherein the input orifice is located at a first position along a circumference of the gear shrouding, and an output orifice formed through the inner surface of the gear shroud extending to the channel, where the output orifice is located at a second position along the circumference of the gear shrouding, and where the second position is different from the first position.

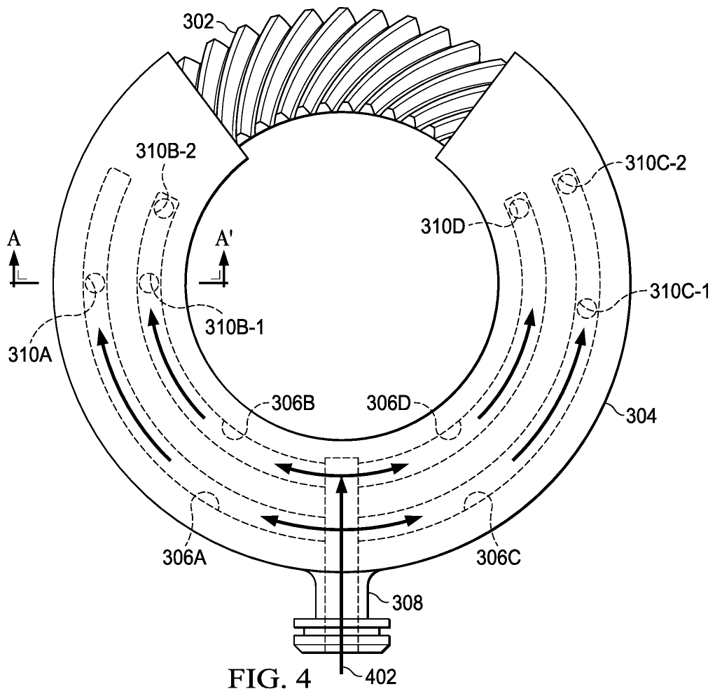

FIG. 4 is a simplified diagram of the exemplary gear shrouding of FIG. 3, in accordance with various embodiments. As shown in FIG. 4, the gear shrouding 304 has a circular portion that partly surrounds the gear 302. The gear shrouding 304 includes one input orifice 308 that extends and connects to four channels 306A, 306B, 306C, 306D. The input orifice 308 is further connected to a fluid source (not shown). The four channels 306 are integrated within the gear shrouding 304 (i.e., between the inner and outer surfaces of the gear shrouding), as indicated by the dotted lines. The gear shrouding 304 further includes six output orifices 310A, 310B-1, 310B-2, 310C-1, 310C-2, 310D on an inner surface of the gear shrouding 304, as indicated by the dotted circles, that extend and connect to their respective channels 306. For example, channel 306A includes one output orifice 310A, channel 306B includes two output orifices 310B-1 and 310B-2, channel 306C includes two output orifices 310C-1 and 310C-2, and channel 306D includes one output orifice 310D. As shown in FIG. 4, the input orifice 308 is positioned below or lower than the output orifices 310. The gear shrouding 304 is designed for lubricant 402 to flow through the input orifice 308, through the four channels 306, and through the six output orifices 310 to be dispensed on the gear 302. In some embodiments, the input orifice 308 is further connected to a pump (not shown).

The input orifice 308 may have any suitable size and shape for providing lubricant to the channels 306 and the output orifices 310 for dispensing on the gear 302. The channels 306 may have any suitable size and shape. For example, the channel 306 may have a partial circular or arc shape, as shown in FIG. 4, may have a straight line shape, or may have another shape. In some embodiments, the channels 306 have a same dimension. In some embodiments, the channels 306 have different dimensions. For example, channel 306A may have a smaller dimension (e.g., diameter and/or length) than channel 306B. In some embodiments, the channels 306 have a cross-section that is circular or round. In some embodiments, the channels 306 have a cross-section that is non-circular or non-round, such as oval, triangular, or rectangular. The output orifices 310 may have any suitable size and shape. In some embodiments, the output orifices 310 are openings or holes on the inner surface of the gear shrouding 304 that extend to connect with their respective channel 306. In some embodiments, the output orifices 310 have a cone or funnel shape when extending to connect with their respective channel 306 (e.g., the diameter of the output orifice is narrower or smaller closer to the channel and wider or large closer to the inner surface of the gear shrouding). In some embodiments, the output orifices 310 have a same shape. In some embodiments, the output orifices 310 have different shapes. In some embodiments, the output orifices 310 have a same dimension. In some embodiments, the output orifices 310 have different dimensions. For example, output orifice 310B-1 may have a smaller dimension (e.g., diameter) than output orifice 310B-2. In some embodiments, the output orifices 310 have a cross-section that is circular or round. In some embodiments, the output orifices 310 have a cross-section that is non-circular or non-round, such as oval, triangular, or rectangular.

The gear shrouding 304 may be constructed using any suitable process and design. For example, the gear shroud 304 having an input orifice 308, a channel 306, and an output orifice 310 may be additively manufactured or machined from a stock material using subtractive manufacturing techniques. The gear shrouding 304 may be constructed of any suitable material (e.g., to withstand operating temperatures and to provide mechanical support), such as thermoplastics, mold material, and steel or other metal.

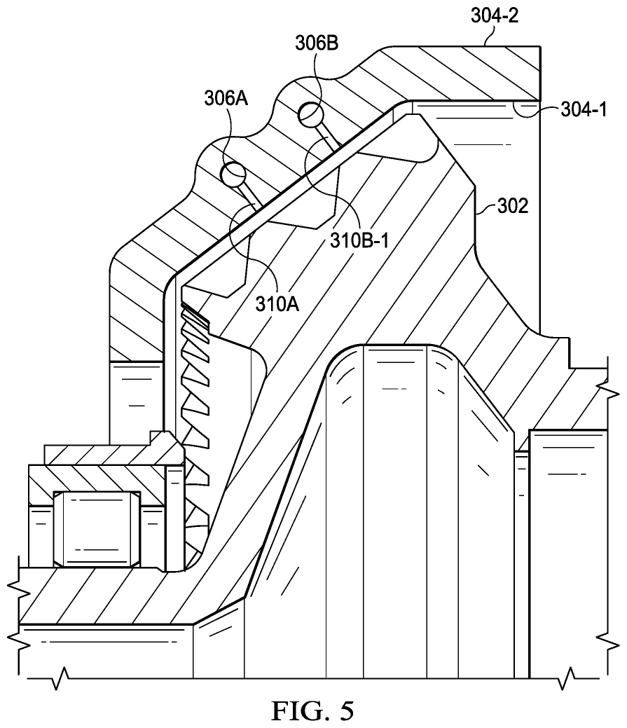

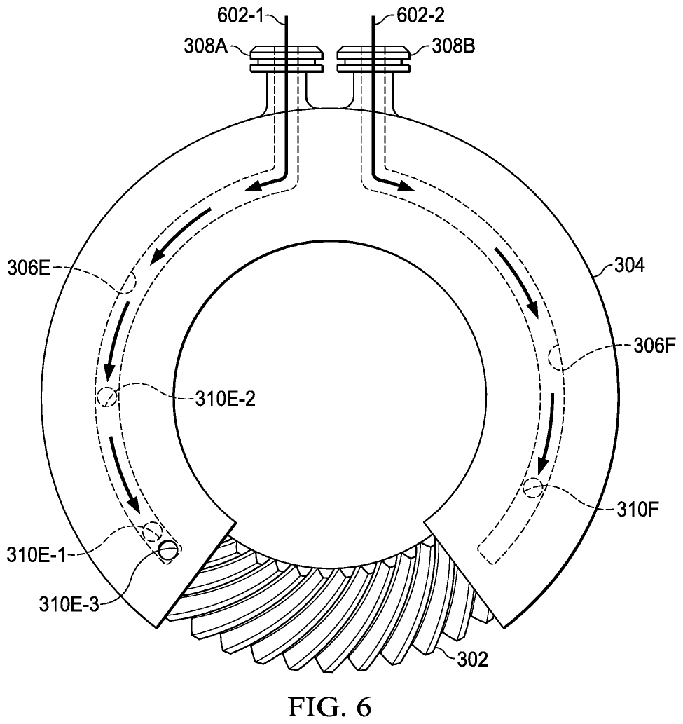

FIG. 5 is a cross sectional view along the A-A′ line of the exemplary gear shrouding of FIG. 4, in accordance with various embodiments. As shown in FIG. 5, the gear shrouding 304 partially surrounds the gear 302. The gear shrouding 304 has an inner surface 304-1 that faces towards the gear 302 and an opposing outer surface 304-2 that faces away from the gear 302. The gear shrouding 304 includes the two channels 306A, 306B. The two channels 306A, 306B are integrated within the gear shrouding 304 between the inner surface 304-1 and outer surface 304-2. Although FIG. 5 shows the channels 306 as causing protrusions or bulges on the outer surface 304-2 of the gear shrouding 304, in some embodiments, the channels 306 may not cause protrusions on the outer surface 304-2 of the gear shrouding 304. The gear shrouding 304 further includes output orifices 310A, 310B-1 on the inner surface 304-1 of the gear shrouding 304 that extend and connect to their respective channels 306A, 306B. When operating, lubricant flows through the channels 306 and the output orifices 310 and is dispensed on the gear 302.

FIG. 6 is a simplified diagram of another exemplary gear shrouding with integral lubricating features, in accordance with various embodiments. As shown in FIG. 6, the gear shrouding 304 has a circular portion that partly surrounds a gear 302. The gear shrouding 304 includes two input orifices 308A, 308B and two channels 306E, 306F. The input orifice 308A extends and connects to channel 306E, and the input orifice 308B extends and connects to channel 306F. The input orifices 308A, 308B are further connected to one or more fluid sources (not shown). The channels 306 are integrated within the gear shrouding 304 (i.e., between the inner and outer surfaces of the gear shrouding), as indicated by the dotted lines. The gear shrouding 304 further includes four output orifices 310E-1, 310E-2, 310E-3, 310F that extend and connect to their respective channels 306. Three output orifices 310E-1, 310E-2, 310F are located on the inner surface of the gear shrouding 304, as indicated by the dotted circles, and one output orifice 310E-3 is located on the outer surface of the gear shrouding 304, as indicated by the solid line circle. For example, channel 306E includes three output orifices 310E-1, 310E-2, 310E-3, and channel 306F includes one output orifice 310F. As shown in FIG. 6, the input orifice 308 is positioned above or higher than the output orifices 310. The gear shrouding 304 is designed for lubricant 602-1, 602-2 to flow through the input orifices 308A, 308B, through the two channels 306E, 306F, and through the four output orifices 310E-1, 310E-2, 310E-3, 310F to be dispensed on the gear 302. In some embodiments, the input orifice 308 is further connected to a pump (not shown). In some embodiments, the lubricant 602-1, 602-2 is pressurized. In some embodiments, the lubricant 602-1, 602-2 flows through the gear shrouding by gravity driven fluid flow.

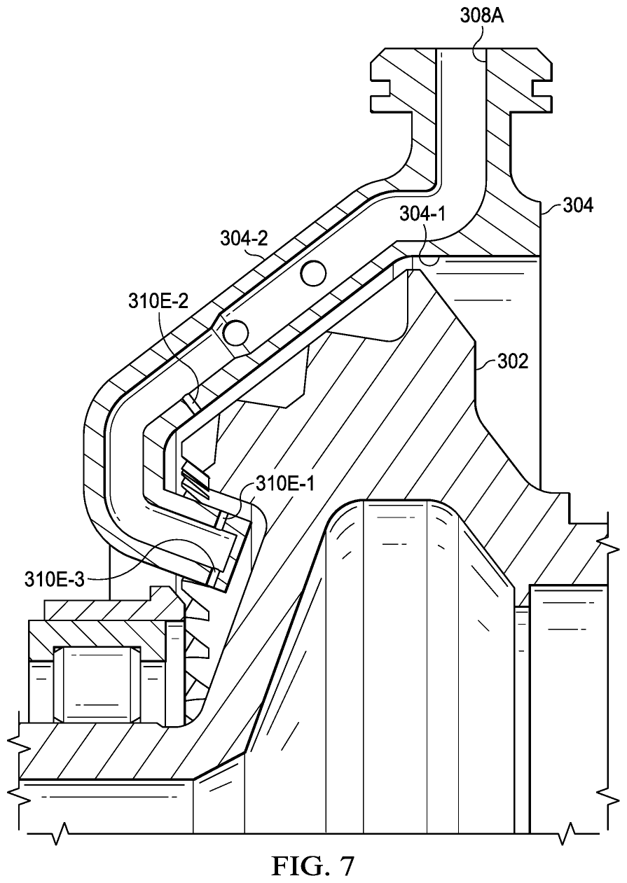

FIG. 7 is a cross-sectional, side view of exemplary gear shrouding of FIG. 6 along channel 306E, in accordance with various embodiments. As shown in FIG. 7, the gear shrouding 304 partially surrounds the gear 302. The gear shrouding 304 has an inner surface 304-1 that faces towards the gear 302 and an opposing outer surface 304-2 that faces away from the gear 302. The gear shrouding 304 includes the input orifice 308A and the channel 306E. The channel 306E is integrated within the gear shrouding 304 between the inner surface 304-1 and outer surface 304-2. Although FIG. 7 shows the channel 306 as not causing protrusions or bulges on the outer surface 304-2 of the gear shrouding 304, in some embodiments, the channel 306 may cause protrusions on the outer surface 304-2 of the gear shrouding 304. The gear shrouding 304 further includes two output orifices 310E-1, 310E-2 on the inner surface 304-1 of the gear shrouding 304 and one output orifice 310E-3 on the outer surface 304-2 of the gear shrouding 304, where the output orifices 310E extend and connect to the channel 306E. When operating, lubricant flows through the channel 306E and the output orifices 310E and is dispensed on and adjacent to the gear 302.

Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

In order to assist the United States Patent and Trademark Office (USPTO), and any readers of any patent issued on this application, in interpreting the claims appended hereto, it is noted that: (a) Applicant does not intend any of the appended claims to invoke paragraph (f) of 35 U.S.C. § 112, as it exists on the date of the filing hereof, unless the words “means for” or “steps for” are explicitly used in the particular claims; and (b) Applicant does not intend, by any statement in the specification, to limit this disclosure in any way that is not otherwise expressly reflected in the appended claims.

What is claimed is:

1. A gear shrouding, having an inner surface and an opposing outer surface, for lubricating a gear in a gearbox, comprising:
a channel formed along at least a portion of the gear shrouding between the inner surface and the outer surface of the gear shrouding;
an input orifice extending to the channel, wherein the input orifice is at a first position on the channel; and
an output orifice extending to the channel, wherein the output orifice is at a second position on the channel, and wherein the second position is different from the first position.

2. The gear shrouding of claim 1, wherein the output orifice is a first output orifice, and further comprising:
a second output orifice extending to the channel, wherein the second output orifice is at a third position on the channel, and wherein the third position is different from the first position and the second position.

3. The gear shrouding of claim 2, wherein the first and second output orifices are through the inner surface of the gear shrouding.

4. The gear shrouding of claim 2, wherein the first output orifice is through the inner surface of the gear shrouding and the second output orifice is through the outer surface of the gear shrouding.

5. The gear shrouding of claim 1, wherein the channel is a first channel and the output orifice is a first output orifice, and further comprising:
a second channel formed along at least a portion of the gear shrouding between the inner surface and the outer surface of the gear shrouding, wherein the input orifice further extends to the second channel; and
a second output orifice extending to the second channel, wherein the second output orifice is at a third position on the channel, and wherein the third position is different from the first position.

6. The gear shrouding of claim 5, wherein the input orifice is a first input orifice extending to the first channel, and further comprising:
a second input orifice extending to the second channel at a fourth position along different from the third position.

7. The gear shrouding of claim 1, wherein the input orifice at the first position is located below the output orifice at the second position.

8. The gear shrouding of claim 1, wherein the input orifice at the first position is located above the output orifice at the second position.

9. An aircraft gearbox, comprising:
a gear; and
a gear shrouding disposed around the gear having an inner surface facing the gear and an opposing outer surface facing away from the gear, the gear shrouding comprising:
a channel formed along at least a portion of the gear shrouding between the inner surface and the outer surface of the gear shrouding;
an input orifice extending to the channel, wherein the input orifice is at a first position along a length of the channel; and
an output orifice extending to the channel, wherein the output orifice is at a second position along the length of the channel, and wherein the second position is different from the first position.

10. The aircraft gearbox of claim 9, wherein the output orifice of the gear shrouding is a first output orifice, and the gear shrouding further comprises:
a second output orifice extending to the channel, wherein the second output orifice is at a third position on the channel, and wherein the third position is different from the first position and the second position.

11. The aircraft gearbox of claim 10, wherein the first and second output orifices are through the inner surface of the gear shrouding.

12. The aircraft gearbox of claim 10, wherein the first output orifice is through the inner surface of the gear shrouding and the second output orifice is through the outer surface of the gear shrouding.

13. The aircraft gearbox of claim 9, wherein the channel of the gear shrouding is a first channel and the output orifice of the gear shrouding is a first output orifice, and the gear shrouding further comprises:
a second channel formed along at least a portion of the gear shrouding between the inner surface and the outer surface of the gear shrouding, wherein the input orifice further extends to the second channel; and
a second output orifice extending to the second channel, wherein the second output orifice is at a third position on the channel, and wherein the third position is different from the first position.

14. The aircraft gearbox of claim 9, wherein the aircraft gearbox is a spiral bevel gearbox, a spindle gearbox, a proprotor gearbox, an accessory gearbox, a reduction gearbox, a combining gearbox, a main rotor gearbox, or a tail rotor gearbox.

15. A rotorcraft, comprising:
a fuselage;
an engine coupled to the fuselage; and
a gearbox coupled to the engine, the gearbox comprising:
a gear; and
a gear shrouding disposed around the gear having an inner surface facing the gear and an opposing outer surface facing away from the gear, the gear shrouding comprising:
a channel formed along at least a portion of the gear shrouding between the inner surface and the outer surface of the gear shrouding;
an input orifice formed through the outer surface of the gear shrouding extending to the channel, wherein the input orifice is at a first position along a length of the channel; and
an output orifice formed through the inner surface or the outer surface of the gear shrouding extending to the channel, wherein the output orifice is at a second position along the length of the channel, and wherein the second position is different from the first position.

16. The rotorcraft of claim 15, wherein the output orifice of the gear shrouding is a first output orifice, and wherein the gear shrouding further comprises:
a second output orifice extending to the channel, wherein the second output orifice is at a third position on the channel, and wherein the third position is different from the first position and the second position.

17. The rotorcraft of claim 16, wherein the first and second output orifices are through the inner surface of the gear shrouding.

18. The rotorcraft of claim 16, wherein the first output orifice is through the inner surface of the gear shrouding and the second output orifice is through the outer surface of the gear shrouding.

19. The rotorcraft of claim 15, wherein the channel of the gear shrouding is a first channel and the output orifice of the gear shrouding is a first output orifice, and the gear shrouding further comprises:
a second channel formed along at least a portion of the gear shrouding between the inner surface and the outer surface of the gear shrouding, wherein the input orifice further extends to the second channel; and
a second output orifice extending to the second channel, wherein the second output orifice is at a third position on the channel, and wherein the third position is different from the first position.

20. The rotorcraft of claim 15, wherein the gearbox is a spiral bevel gearbox, a spindle gearbox, a proprotor gearbox, an accessory gearbox, a reduction gearbox, a combining gearbox, a main rotor gearbox, or a tail rotor gearbox.
